(19) United States
(12) Patent Application Publication
(10) Pub. No.: US 2015/0372383 A1
(43) Pub. Date: Dec. 24, 2015

(54) DUAL BAND ANTENNA DEVICE

(71) Applicant: NEC CORPORATION, Minato-ku, Tokyo (JP)

(72) Inventor: Takahide YOSHIDA, Tokyo (JP)

(73) Assignee: NEC CORPORATION, Tokyo (JP)

(21) Appl. No.: 14/763,258

(22) PCT Filed: Feb. 14, 2014
(86) PCT No.: PCT/JP2014/000761

§ 371 Date: Jul. 24, 2015

(30) Foreign Application Priority Data
Feb. 18, 2013 (JP) 2013-028747

(51) Int. Cl. H01Q 5/335; H01Q 21/00; H01Q 5/10; H01Q 1/50

(52) U.S. Cl. CPC H01Q 5/335; H01Q 1/50; H01Q 21/0006; H01Q 5/10

(57) ABSTRACT

A dual band antenna device includes a first antenna unit which includes a first long element, a first short element whose resonant frequency is different from the resonant frequency of the first long element, a first frequency adjustment element provided in the first long element to adjust the resonant frequency, and a first power feeding port that is a power feeding end; a second antenna unit which includes a second long element, a second short element whose resonant frequency is different from the resonant frequency of the second long element, a second frequency adjustment element provided in the second long element to adjust the resonant frequency, and a second power feeding port that is a power feeding end; and a coupling element which connects the first antenna unit and the second antenna unit while adjusting a mutual impedance between the first antenna unit and a second antenna unit.

### TECHNICAL FIELD

The present invention relates to a dual band antenna device which transmits and receives an electric wave in a plurality of frequency bands.

### BACKGROUND ART

In recent years, a MIMO (Multiple-Input Multiple-Output) system is widely used and for this reason a wireless communication device such as a portable communication terminal begins to use an antenna device including a plurality of antenna units with the same resonant frequency. In this MIMO system, a spatial multiplexing transmission in which different information streams are transmitted by a plurality of antennas of a transmission side and received by a plurality of antennas of a reception side is adopted and whereby, a transmission capacity is increased.

However, when a plurality of antenna units with the same resonant frequency are closely arranged in the portable communication terminal having a small mounting area, an electromagnetic coupling occurs between the antenna units and whereby, an antenna radiation efficiency is reduced and a signal is deteriorated by the increase of the correlation coefficient.

As a countermeasure to this problem, for example, in Japanese Patent Publication No. 4723673, the antenna having a structure shown in FIG. 14 is proposed. In this antenna, adjacent antenna elements 101 and 102 are connected by a connection element and whereby, an admittance element between the antenna units generated by electromagnetic coupling is canceled.

### CITATION LIST

### Patent Literature

[PTL 1] Japanese Patent Publication No. 4723673

### DISCLOSURE OF INVENTION

### Technical Problem

However, in the antenna described in Japanese Patent Publication No. 4723673, because an isolation effect by the connection element is sensitive to a frequency phase characteristic between the antennas, it is effective only in a specific narrow frequency band and whereby, a problem in which a frequency bandwidth of the antenna is reduced occurs.

When a low profile and miniaturization of the antenna in which the connection element is connected are realized, the radiation resistance of the antenna decreases and a Q-value increases. Accordingly, a problem in which the frequency bandwidth is further reduced occurs.

Accordingly, a main object of the present invention is to provide a dual band antenna device in which a frequency bandwidth is prevented from being reduced even in an antenna device using the connection element.

### Solution to Problem

In order to solve the above-mentioned problem, a dual band antenna device which transmits and receives an electric wave in a plurality of frequency bands is characterized by including a first antenna unit which includes a first long element, a first short element whose resonant frequency is different from the resonant frequency of the first long element, a first frequency adjustment element that is provided in the first long element to adjust the resonant frequency, and a first power feeding port that is a power feeding end; a second antenna unit which includes a second long element, a second short element whose resonant frequency is different from the resonant frequency of the second long element, a second frequency adjustment element that is provided in the second long element to adjust the resonant frequency, and a second power feeding port that is a power feeding end; and a coupling element which connects the first antenna unit and the second antenna unit while adjusting a mutual impedance between the first antenna unit and the second antenna unit.

### Advantageous Effects of Invention

By using the present invention, the frequency bandwidth can be prevented from being reduced by using a predetermined coupling element and a frequency adjustment element.

### BRIEF DESCRIPTION OF DRAWINGS

FIG. 1 is a figure showing a structure of an antenna device according to a first exemplary embodiment of the present invention,

FIG. 2 is a figure showing a relation between S parameter of an antenna device and frequency,

FIG. 3 is a figure showing a correlation coefficient indicating a correlation between signals received by power feeding ports,

FIG. 4 is a figure showing a radiation efficiency when a power is supplied via a first power feeding port in an antenna device,

FIG. 5 shows a change of an S parameter when a height of a frequency adjustment element is changed,

FIG. 6 is a perspective view of an antenna device including a plurality of first antenna units and a plurality of second antenna units,

FIG. 7A is a figure showing a frequency adjustment element formed in a projection shape,

FIG. 7B is a figure showing a frequency adjustment element formed in a ring shape,

FIG. 7C is a figure showing a frequency adjustment element formed in a T shape,

FIG. 8 is a figure showing a frequency adjustment element that is composed of an inductor and a capacitor,

FIG. 9 is a figure showing a structure of an antenna device according to a second exemplary embodiment of the present invention,

FIG. 10 is a figure showing a relation between S parameter of an antenna device and frequency,

FIG. 11 is a figure showing a radiation efficiency of an antenna device,

FIG. 12 is a figure showing a structure of an antenna device according to a third exemplary embodiment of the present invention,

FIG. 13 is a figure showing a structure of an antenna device in which an antenna unit is folded, and

FIG. 14 is a figure showing a structure of an antenna used when explaining the related technology.

### DESCRIPTION OF EMBODIMENTS

### First Exemplary Embodiment

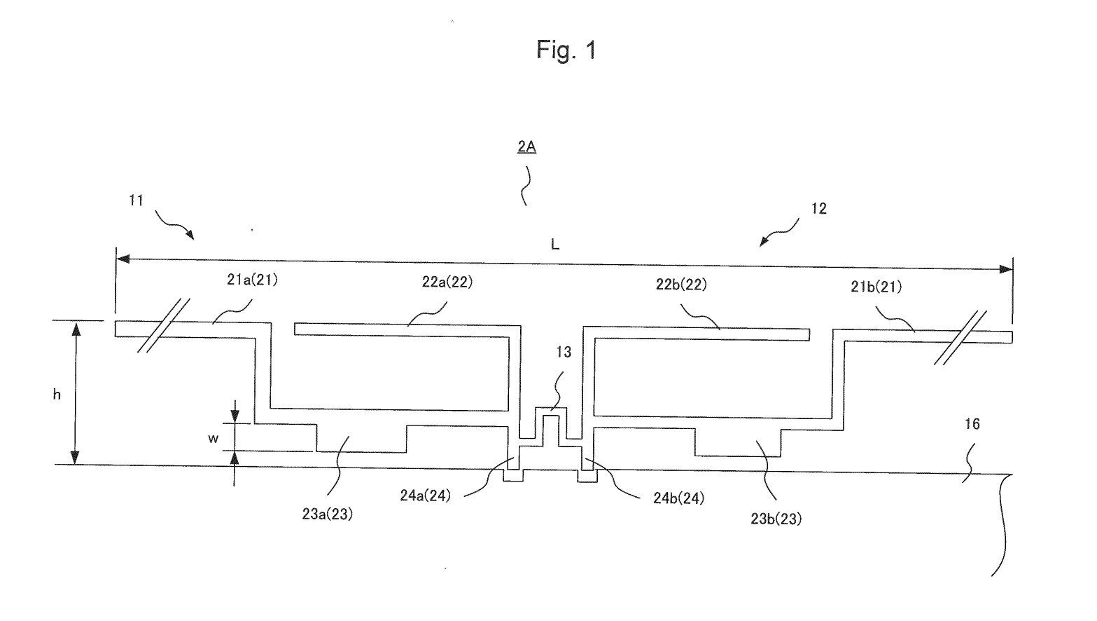

Next, a first exemplary embodiment of the present invention will be described. FIG. 1 is a figure showing a structure of an antenna device 2A according to the first exemplary embodiment. The antenna device 2A is composed of a first antenna unit 11, a second antenna unit 12, and a coupling element 13 which couples these units to each other as basic elements.

This first antenna unit 11 includes a first long element 21a (21), a first short element 22a (22), a first frequency adjustment element 23a (23), and a first power feeding port 24a (24). Further, the second antenna unit 12 includes a second long element 21b (21), a second short element 22b (22), a second frequency adjustment element 23b (23), and a second power feeding port 24b (24). Here, the word of “long” of the long element 21 (21a and 22a) means that the long element 21 has a branch structure in which a length of the branch is greater than that of the short element 22 (22a and 22b). Namely, the length of the long element 21 is different from the length of the short element 22, the length of the long element 21 is greater than the length of the short element 22, and the resonant frequency of the long element 21 is different from that of the short element 22.

The frequency adjustment element 23 (23a and 23b) is provided in the long element 21 (21a and 21b). The first antenna unit 11 and the second antenna unit 12 are connected to each other by the coupling element 13 and connected to a ground plate 16 via the power feeding port 24 (24a and 24b).

Further, because the first antenna unit 11 and the second antenna unit 12 are formed so as to be in a symmetric fashion, in the following explanation, the first antenna unit 11 may be explained as an example.

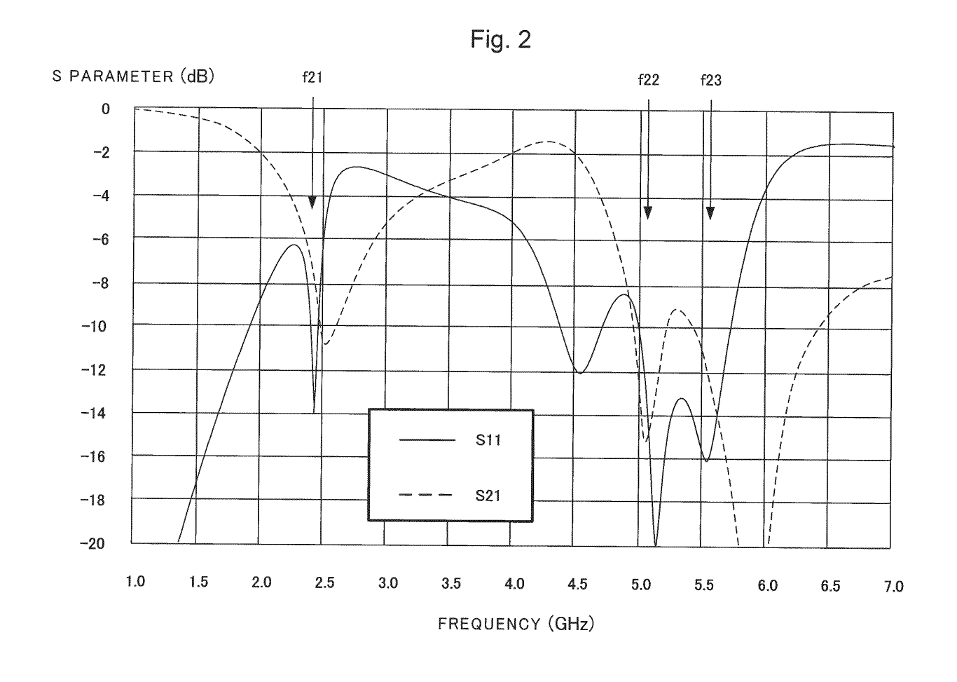

FIG. 2 is a figure showing the relation between the S parameter of the antenna device 2A having the above-mentioned structure and the frequency. Here, in order to transmit and receive the electric waves of 2.4 GHz band and 5 GHz band that are the frequency bands of a WLAN (Wireless Local Area Network), the height h of the antenna device 2A is set to 5.5 mm, the width L of the antenna device 2A is set to 43.6 mm, and the height w of the frequency adjustment element 23 is set to 1.4 mm.

In FIG. 2, an S11 parameter that represents a reflection coefficient of the first power feeding port 24a is shown by a solid line and an S21 parameter that represents a transmission coefficient from the first power feeding port 24a to the second power feeding port 24b is shown by a dotted line. Further, with respect to an S22 parameter that represents the reflection coefficient of the second power feeding port 24b and an S12 parameter that represents the transmission coefficient from the second power feeding port 24b to the first power feeding port 24a, S11=S22 and S12=S21 because the structures of the first antenna unit 11 and the structure of the second antenna unit 12 are formed in a symmetrical fashion.

The antenna device 2A shown in FIG. 1 is connected by the coupling element 13. Accordingly, there is a possibility that the electric power supplied from the first power feeding port 24a is consumed in the second power feeding port 24b or the electric power supplied from the second power feeding port 24b is consumed in the first power feeding port 24a. However, in the present invention, in order to prevent such inconvenience, the impedance of the coupling element 13 by which the first antenna unit 11 and the second antenna unit 12 are coupled to each other is set.

Further, if the coupling element 13 can electrically connect the first antenna unit 11 and the second antenna unit, the structure of the coupling element 13 is not limited and various kinds of structures can be used. For example, the coupling element composed of a bent metal wire or the coupling element formed in a meander shape can be used. Further, the coupling element composed of an inductor, a capacitor, a filter, and a phase shifter can be used.

The impedance setting is performed as follows. First, the coupling element 13 is arranged at a position at which a phase of the S21 parameter is equal to +−π/2 when the antenna units 11 and 12 are viewed from the power feeding point in the antenna device 2A. In this state, the length of the coupling element 13 is adjusted. In these adjustment processes, the current flowing from one power feeding port to the other power feeding port via the coupling element 13 and the ground plate 16 or a space is made minimum. In other words, the value of the S21 parameter is made minimum. By this process, the impedance of the coupling element 13 is adjusted and the inconvenience in which the electric current supplied by one power feeding port flows into the other power feeding port can be prevented.

In FIG. 2, a resonant frequency f21 corresponds to a frequency obtained by combining a primary resonant frequency of the first long element 21a and a primary resonant frequency of the second long element 21b when the electric power is supplied from the first power feeding port 24a. In this case, in a graph showing the S21 parameter, the value of the S21 parameter is reduced at the resonant frequency f21 like the graph showing the S11 parameter. This means that the impedance matching from the first power feeding port 24a is properly set and the first power feeding port 24a and the second power feeding port 24b are isolated from each other. The same applies to a case in which the electric power is supplied from the second power feeding port 24b.

A resonant frequency f22 corresponds to a frequency obtained by combining the primary resonant frequency of the first short element 22a and the primary resonant frequency of the second short element 22b. In a graph showing the S21 parameter and a graph showing the S11 parameter, the values of the S21 parameter and the S11 parameter are reduced at the resonant frequency f22.

On the other hand, in a graph showing the S21 parameter and the graph showing the S11 parameter, the values of the S21 parameter and the S11 parameter are reduced at a resonant frequency f23. This resonant frequency f23 corresponds to a secondary resonant frequency of the first long element 21a and the second long element 21b.

Basically, the secondary resonant frequency f23 of the first long element 21a and the second long element 21b appears around approximately 7.5 GHz that is a frequency of three times of the resonant frequency f21. However, because the first frequency adjustment element 23a and the second frequency adjustment element 23b are connected to each other, the secondary resonant frequency f23 appears around 5.5 GHz as shown in FIG. 2. This means that it is desirable that the frequency adjustment element 23 is arranged at a position one-half of a wavelength away from the end of the first long element 21 when the wire length of the first long element 21 is equal to a length corresponding to three-quarter of the wavelength of the resonant frequency.

When such arrangement is used, the resonant frequency f22 and the resonant frequency f23 are combined and whereby, the antenna device 2A has a wider resonant frequency band than a basic resonant frequency band.

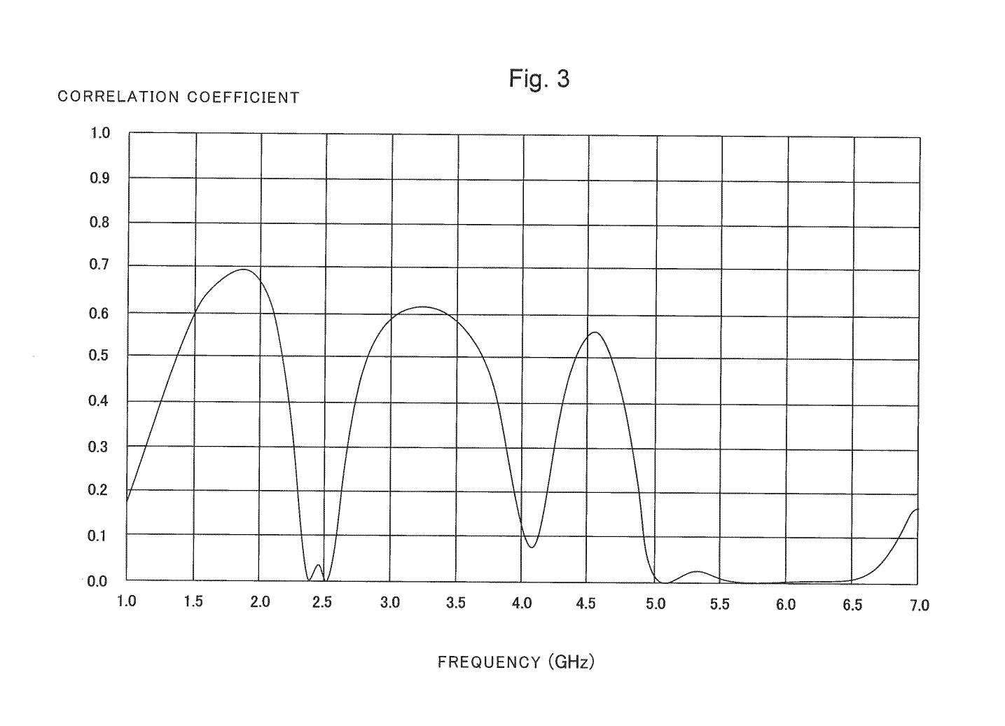

FIG. 3 is a figure showing a correlation coefficient indicating a correlation between signals received by the first power feeding port 24a and the second power feeding port 24b.

Because the correlation coefficient between the ports can be expressed by the following equation 1 using the S parameter, the correlation coefficient can be calculated by using the result shown in FIG. 2.

$${ρ}_{e} = \frac{{\vert {S}_{11}^{*} {S}_{12} + {S}_{21}^{*} {S}_{22} \vert}^{2}}{( 1 - ( {\vert {S}_{11} \vert}^{2} + {\vert {S}_{21} \vert}^{2} ) ) ( 1 - ( {\vert {S}_{22} \vert}^{2} + {\vert {S}_{12} \vert}^{2} ) )} \qquad ( 1 )$$

In FIG. 3, the correlation coefficient is equal to or smaller than 0.1 in 2.4 GHz band and 5 GHz band that are desirable frequency bands. Therefore, it is seen that the antenna device 2A has a sufficiently small correlation coefficient in these bands by which quality of MIMO communication is not degraded.

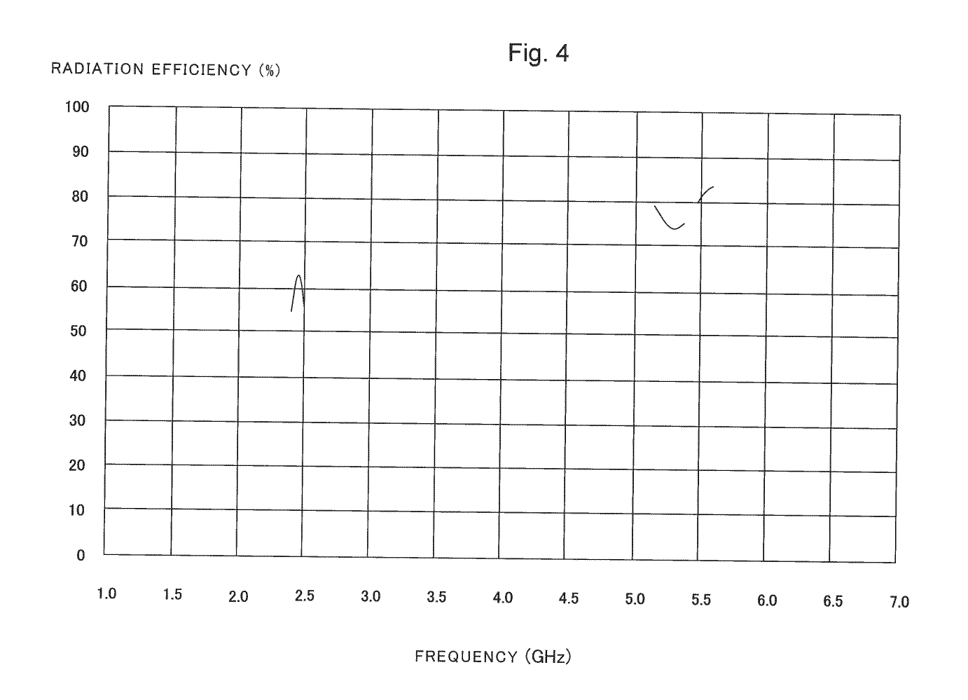

FIG. 4 is a graph showing a radiation efficiency when an electric power is supplied from the first power feeding port 24a in the antenna device 2A shown in FIG. 1. Further, when the electric power is supplied from the second power feeding port 24b, the same result can be obtained. From FIG. 4, it is understood that the antenna device 2A has a sufficiently high radiation efficiency of more than 50% in the desired frequency bands (2.4 GHz band and 5 GHz band) and sufficiently operates as an antenna.

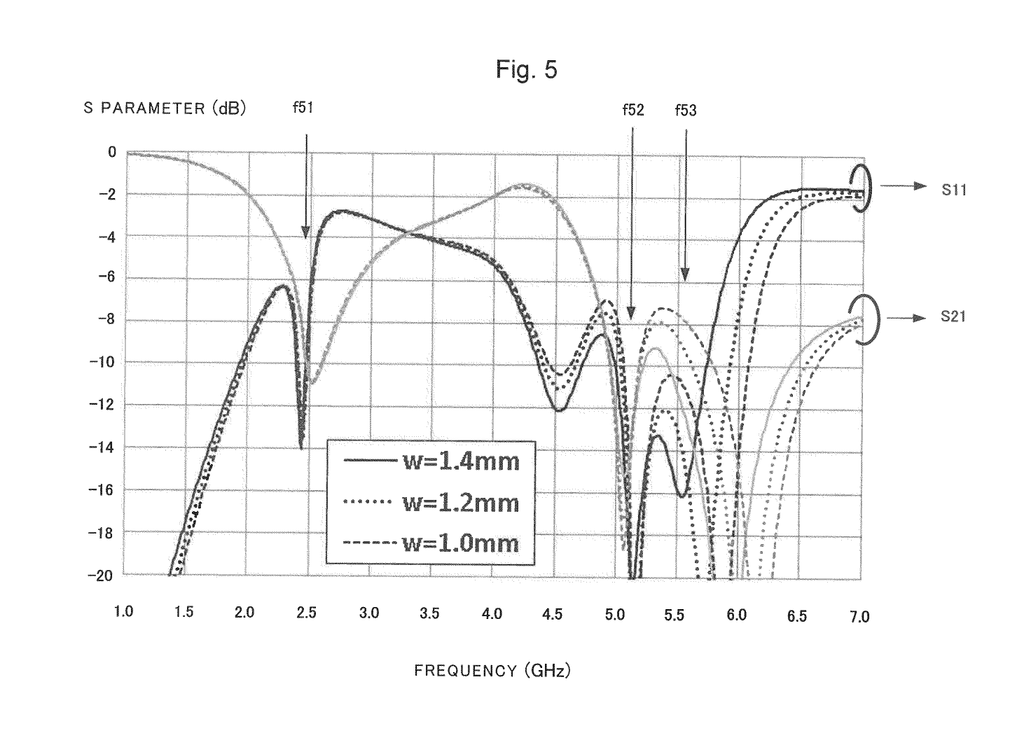

FIG. 5 is a graph showing the S parameter in which the height w of the frequency adjustment element 23 is changed to verify an effect of the frequency adjustment element 23. It is seen that when the height w of the frequency adjustment element 23 is changed to 1.0, 1.2, or 1.4 mm in this order, a secondary resonant frequency f53 of the short element 22 is shifted to a low frequency side in small steps.

On the other hand, a primary resonant frequency f51 of the first long element 21a and the second long element 21b and a primary resonant frequency f52 of the first short element 22a and the second short element 22b are scarcely changed when the height w of the frequency adjustment element 23 is changed.

As described above, by controlling the height (the size) of the frequency adjustment element, the resonant frequency of the antenna device can be freely changed. Further, because the impedance of the coupling element is adjusted, the inconvenience in which the bandwidth of the antenna device is reduced can be prevented.

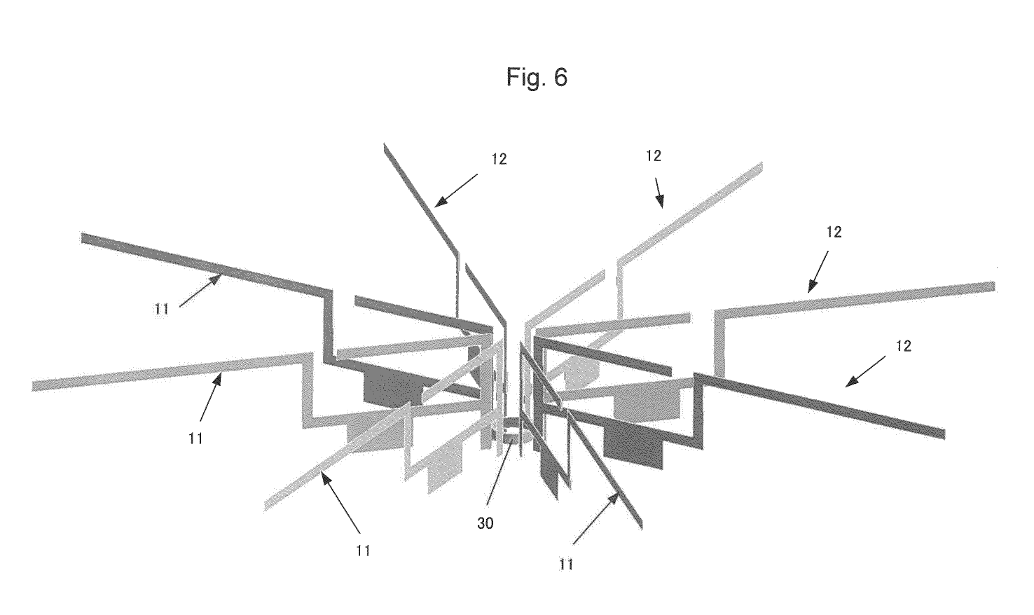

Further, in the above-mentioned description, a case in which the antenna device is composed of a pair of the first antenna unit and the second antenna unit has been explained. However, the present invention is not limited to this structure. For example, as shown in FIG. 6, the antenna device may be composed of a plurality of pairs of the first antenna unit 11 and the second antenna unit 12. In FIG. 6, a case in which four pairs of the first antenna unit 11 and the second antenna unit 12 are arranged radially and coupled by using one coupling element 30 is shown as an example.

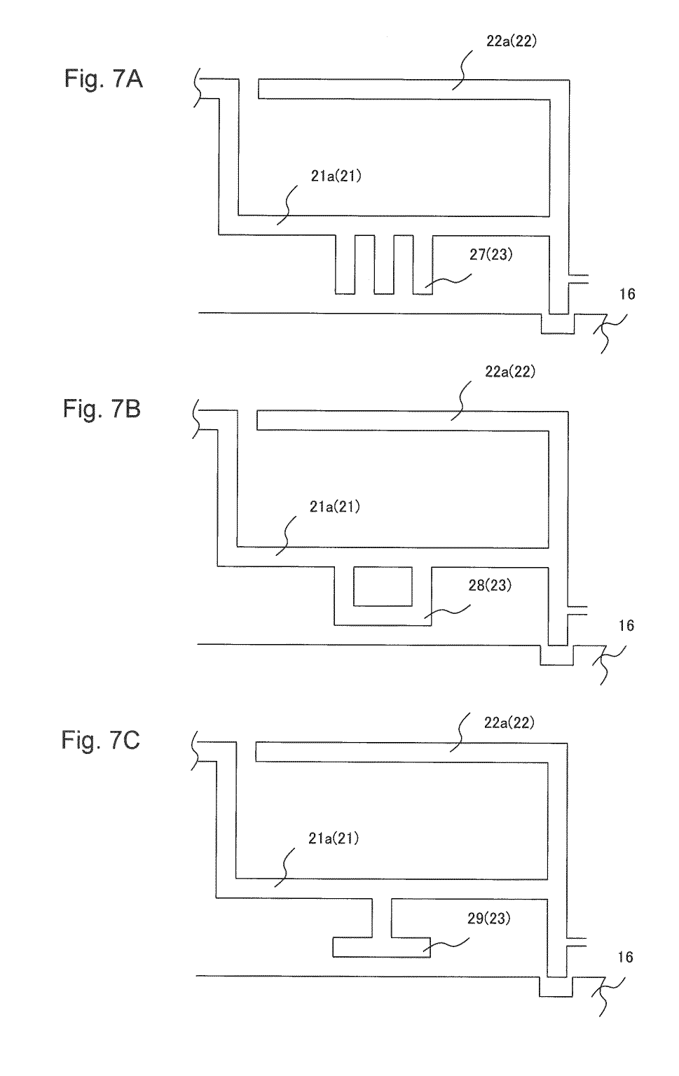

The frequency adjustment element 23 is not limited to the element formed in a rectangle plate shape as shown in FIG. 1 and the frequency adjustment element 23 may have a shape shown in FIGS. 7A to 7C. FIG. 7A shows a frequency adjustment element 27 (23) formed in a projection shape in which a plurality of strip-shaped elements are arranged in a predetermined interval in parallel, FIG. 7B shows a frequency adjustment element 28 (23) formed in a ring shape in which a punched hole is formed, and FIG. 7C shows a frequency adjustment element 29 (23) formed in a T-shape.

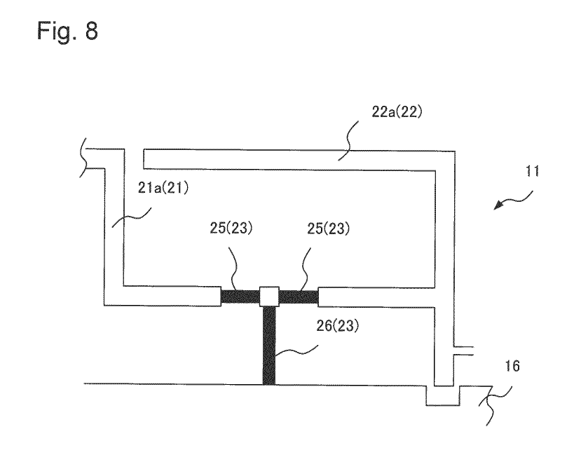

Further, when each of the above-mentioned frequency adjustment elements 23 is capacitively-coupled to the ground plate 16 or coupled by another method, the frequency adjustment element 23 has a frequency adjustment function. However, the frequency adjustment function may be realized by a lumped-parameter element. For example, as shown in FIG. 8, a structure in which two inductors 25 and a capacitor 26 are used and the inductors 25 are inserted between the long elements 21 and the long elements 21 is connected to the ground plate 16 via the capacitor 26 can be used.

### Second Exemplary Embodiment

Next, a second exemplary embodiment of the present invention will be described. Further, the same reference numbers are used for the elements having the same function as the first exemplary embodiment and the description will be omitted appropriately.

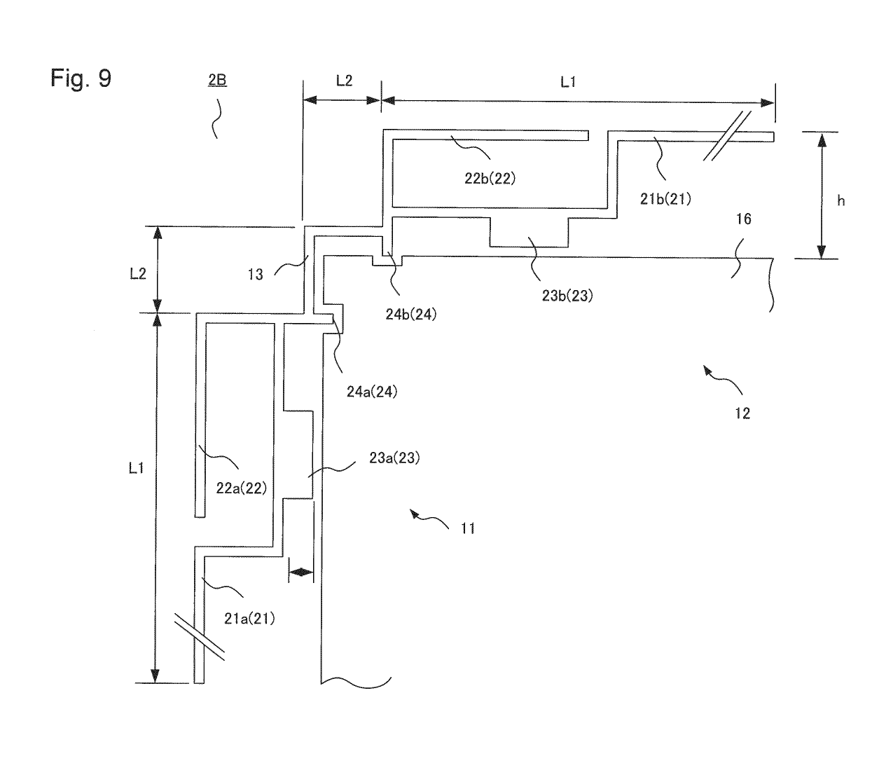

FIG. 9 a figure showing a structure of an antenna device 2B according to this exemplary embodiment. The basic structure of the antenna device 2B is the same as that of the antenna device 2A. However, in the antenna device 2B, the first antenna unit 11 and the second antenna unit 12 are arranged so as to be perpendicular to each other and these units are arranged at a corner of the ground plate 16.

The first power feeding port 24a and the second power feeding port 24b are connected to each other at a position in the vicinity of the corner point of the ground plate 16. The coupling element 13 is laid along the corner and connects the first antenna unit 11 and the second antenna unit 12.

Because a current mode of the above-mentioned inverted L type antenna device 2B composed of the first antenna unit 11 and the second antenna unit 12 is similar to that of a dipole antenna. Therefore, the radiation characteristic of the inverted L type antenna device 2B is improved compared to the antenna device 2A. Of course, it goes without saying that an arrangement of the antenna device 2B to a ground substrate can be determined according to not only the antenna characteristic but also the convenience of assembling of the antenna device 2B.

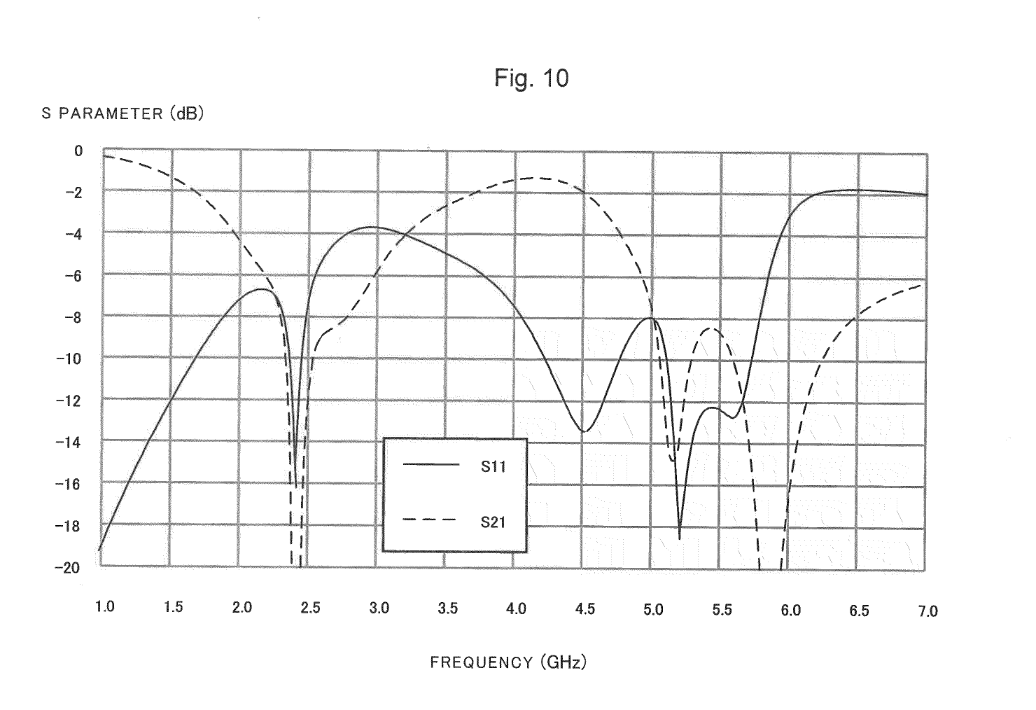

FIG. 10 is a figure showing the relation between the S parameter of the antenna device 2B and the frequency. In this case, the antenna device 2B has a structure in which the height h is 5.5 mm, L1=20.8 mm, and L2=6.5 mm. When the characteristics shown in FIG. 10 is compared with the characteristics shown in FIG. 2, it is seen that the frequency characteristic of the antenna device 2B is similar to that of the antenna device 2A and the values of the S11 parameter and the S21 parameter at 2.4 GHz band of the antenna device 2B are smaller than those of the antenna device 2A.

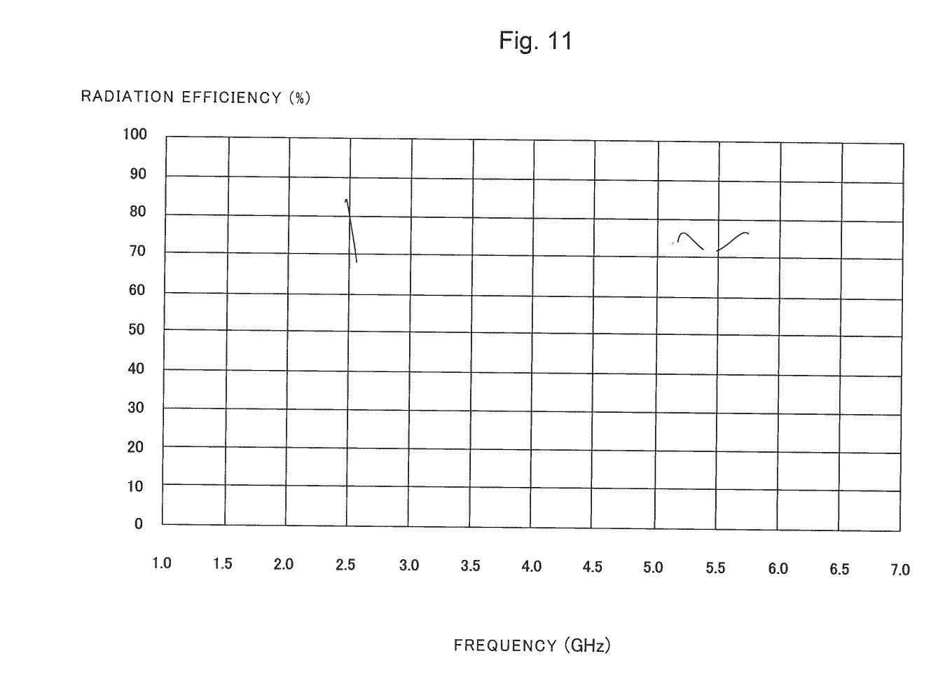

FIG. 11 is a figure showing a radiation efficiency of the antenna device 2B. When the radiation efficiency shown in FIG. 11 is compared with the radiation efficiency shown in FIG. 4, it is seen that the radiation efficiency at 2.4 GHz shown in FIG. 11 is improved more than 10% compared to the radiation efficiency shown in FIG. 4.

Thus, the arrangement and the structure of the first antenna unit and the second antenna unit can be determined from the point of view of assembly and the radiation characteristic of the antenna device. Therefore, the degree of freedom of design can be improved.

### Third Exemplary Embodiment

Next, a third exemplary embodiment of the present invention will be described. Further, the same reference numbers are used for the elements having the same function as the first exemplary embodiment and the description will be omitted appropriately.

The size of the antenna device according to this exemplary embodiment is further reduced compared to the antenna device described above. Namely, in the second exemplary embodiment, the antenna device is arranged at the corner of the ground plate. As a result, the longitudinal length of the antenna device is substantially reduced. In contrast, in this exemplary embodiment, the long element of the antenna device has a meander structure in which the element is formed in a meander shape. As a result, the size of the antenna device is reduced.

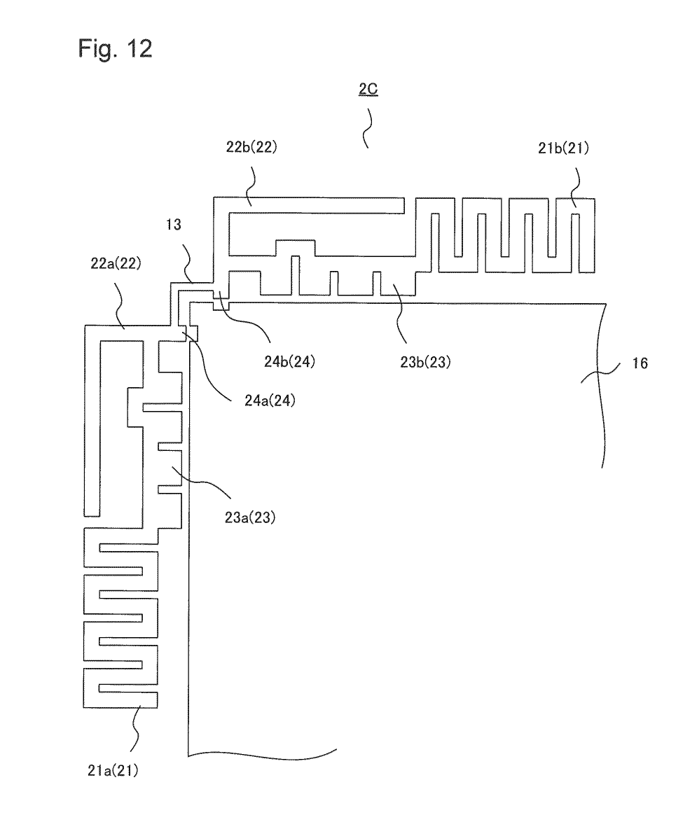

FIG. 12 is a figure showing a structure of an antenna device 2C according to this exemplary embodiment. As shown in FIG. 12, the first antenna unit 11 and the second antenna unit 12 of the antenna device 2C are arranged so as to be perpendicular to each other at the corner of the ground plate and the first long element 21a and the second long element 21b are formed in a meander shape.

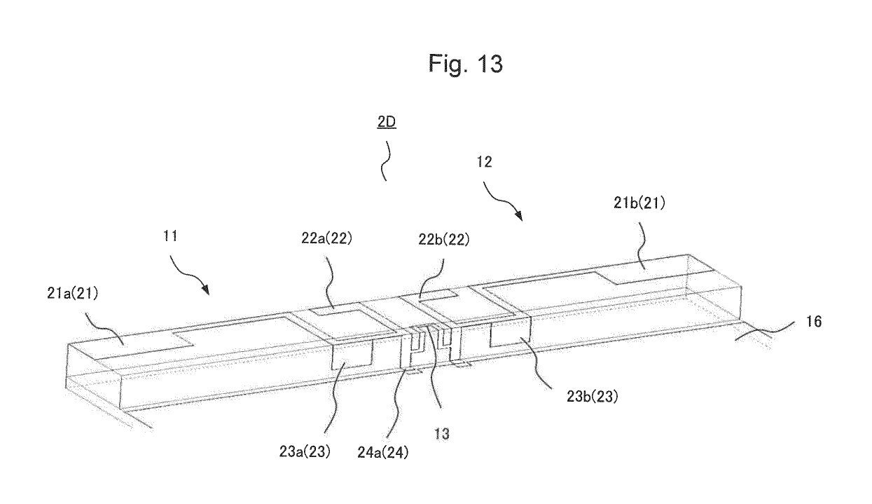

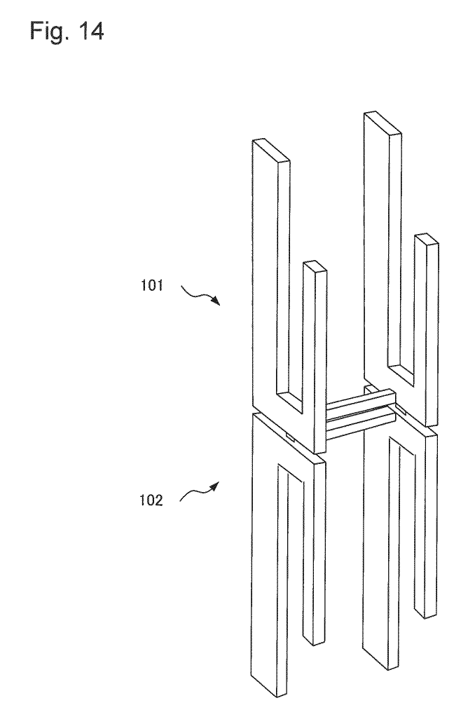

Of course, the miniaturization of the antenna device is not limited to the structure shown in FIG. 12. For example, as shown in FIG. 13, an antenna device 2D in which the antenna device is folded at a position of the first frequency adjustment element 23 and the antenna device is three-dimensionally formed can be used.

### INDUSTRIAL APPLICABILITY

The present invention can be applied to a base station and a terminal for mobile communication using a dual band antenna device and a MIMO wireless communication device such as a route of a wireless LAN (Local Area Network), a terminal, and the like.

A part of or all of the above-mentioned exemplary embodiment can be described as the following supplementary note. However, the present invention is not limited to the following supplementary note.

<Supplementary Note 1>

A dual band antenna device which transmits and receives an electric wave in a plurality of frequency bands characterized by including

a first antenna unit which includes a first long element, a first short element whose resonant frequency is different from the resonant frequency of the first long element, a first frequency adjustment element that is provided in the first long element to adjust the resonant frequency, and a first power feeding port that is a power feeding end;

a second antenna unit which includes a second long element, a second short element whose resonant frequency is different from the resonant frequency of the second long element, a second frequency adjustment element that is provided in the second long element to adjust the resonant frequency, and a second power feeding port that is a power feeding end; and

a coupling element which connects the first antenna unit and the second antenna unit while adjusting a mutual impedance between the first antenna unit and a second antenna unit.

<Supplementary Note 2>

The dual band antenna device described in supplementary note 1 characterized in that

a plurality of pairs of the first antenna unit and the second antenna unit are provided and one coupling element connects a plurality of pairs of these antenna units to each other.

<Supplementary Note 3>

The dual band antenna device described in supplementary note 1 or supplementary note 2 characterized in that

the first antenna unit and the second antenna unit are arranged in a ground plate and the first frequency adjustment element and the second frequency adjustment element are provided so as to be electrically coupled to the ground plate.

<Supplementary Note 4>

The dual band antenna device described in any one of supplementary notes 1 to 3 characterized in that the first short element and the second short element are arranged so that the distance between the first and second short elements and the ground plate is greater than the distance between the first and second long elements and the ground plate.

<Supplementary Note 5>

The dual band antenna device described in any one of supplementary notes 1 to 4 characterized in that the first frequency adjustment element and the second frequency adjustment element are arranged at a position one-half of a wavelength away from the end of the element when the secondary resonance of the first long element and the second long element occurs.

<Supplementary Note 6>

The dual band antenna device described in any one of supplementary notes 1 to 5 characterized in that the first antenna unit and the second antenna unit are arranged at a corner position of the ground plate.

<Supplementary Note 7>

The dual band antenna device described in any one of supplementary notes 1 to 6 characterized in that the first long element and the second long element are formed in a meander shape.

<Supplementary Note 8>

The dual band antenna device described in any one of supplementary notes 1 to 7 characterized in that the first long element and the second long element are folded at the positions of the first frequency adjustment element and the second frequency adjustment element, respectively.

<Supplementary Note 9>

The dual band antenna device described in any one of supplementary notes 1 to 8 characterized in that the frequency adjustment element is formed in any one of a rectangle shape, a projection shape, a ring shape, and a T-shape.

<Supplementary Note 10>

The dual band antenna device described in any one of supplementary notes 1 to 8 characterized in that the frequency adjustment element is formed by an inductor and a capacitor and one end of the capacitor is connected to the ground plate.

<Supplementary Note 11>

The dual band antenna device described in any one of supplementary notes 1 to 10 characterized in that the coupling element is formed by a metal wire and bent or formed in a meander shape.

<Supplementary Note 12>

The dual band antenna device described in any one of supplementary notes 1 to 10 characterized in that the coupling element is formed by using one of an inductor, a capacitor, a filter, and a phase-shifter.

The invention of the present application has been described above with reference to the exemplary embodiment (example). However, the invention of the present application is not limited to the above mentioned exemplary embodiment (example). Various changes in the configuration or details of the invention of the present application that can be understood by those skilled in the art can be made without departing from the scope of the invention of the present application.

This application claims priority from Japanese Patent Application No. 2013-028747 filed on Feb. 18, 2013, the disclosure of which is hereby incorporated by reference in its entirety.

### REFERENCE SIGNS LIST

2A to 2D antenna device

11 first antenna unit

12 second antenna unit

13 and 30 coupling element

16 ground plate

21 long element

21a first long element

21b second long element

22 short element

22a first short element

22b second short element

23 and 27 to 29 frequency adjustment element

23a first frequency adjustment element

23b second frequency adjustment element

24 power feeding port

24a first power feeding port

24b second power feeding port

25 inductor

26 capacitor

1-12. (canceled)

13. A dual band antenna device which transmits and receives an electric wave in a plurality of frequency bands comprising
a first antenna unit which includes a first long element, a first short element whose resonant frequency is different from the resonant frequency of the first long element, a first frequency adjustment element that is provided in the first long element to adjust the resonant frequency, and a first power feeding port that is a power feeding end;
a second antenna unit which includes a second long element, a second short element whose resonant frequency is different from the resonant frequency of the second long element, a second frequency adjustment element that is provided in the second long element to adjust the resonant frequency, and a second power feeding port that is a power feeding end; and
a coupling element which connects the first antenna unit and the second antenna unit while adjusting a mutual impedance between the first antenna unit and a second antenna unit.

14. The dual band antenna device according to claim 13; wherein
a plurality of pairs of the first antenna unit and the second antenna unit are provided and the one coupling element connects a plurality of pairs of these antenna units to each other.

15. The dual band antenna device according to claim 14; wherein
the first antenna unit and the second antenna unit are arranged in a ground plate and the first frequency adjustment element and the second frequency adjustment element are arranged so as to be electrically coupled to the ground plate.

16. The dual band antenna device according to claim 15; wherein
the first short element and the second short element are arranged so that the distance between the first and second short elements and the ground plate is greater than the distance between the first and second long elements and the ground plate.

17. The dual band antenna device according to claim 16; wherein
the first frequency adjustment element and the second frequency adjustment element are arranged at a position one-half of a wavelength away from the end of the element when the secondary resonance of the first long element and the second long element occurs.

18. The dual band antenna device according to claim 17; wherein
the first antenna unit and the second antenna unit are arranged at a corner position of the ground plate.

19. The dual band antenna device according to claim 18; wherein
the first long element and the second long element are formed in a meander shape.

20. The dual band antenna device according to claim 19; wherein
the first long element and the second long element are folded at positions of the first frequency adjustment element and the second frequency adjustment element, respectively.

21. The dual band antenna device according to claim 20; wherein
the frequency adjustment element is formed in one of a rectangle shape, a projection shape, a ring shape, and a T-shape.

22. The dual band antenna device according to claim 20; wherein
the frequency adjustment element is formed by an inductor and a capacitor and one end of the capacitor is connected to the ground plate.

23. The dual band antenna device according to claim 20; wherein
the coupling element is formed by a metal wire and bent or formed in a meander shape.

24. The dual band antenna device according to claim 20; wherein
the coupling element is formed by using one of an inductor, a capacitor, a filter, and a phase-shifter.
